(19) United States
(12) Patent Application Publication
(10) Pub. No.: US 2026/0112742 A1
(43) Pub. Date: Apr. 23, 2026

(54) BATTERIES AND BATTERY SEALS

(71) Applicant: FORD GLOBAL TECHNOLOGIES, LLC, Dearborn, MI (US)

(72) Inventors: Keonseok OH, Novi, MI (US); Chi PAIK, Grosse Ile, MI (US)

(21) Appl. No.: 18/918,831

(22) Filed: Oct. 17, 2024

(51) Int. Cl. H01M 50/105; B23K 26/20; B23K 101/36; B29C 65/16; B29L 31/34; H01M 10/0525; H01M 10/0587; H01M 50/119; H01M 50/121; H01M 50/129; H01M 50/136; H01M 50/178; H01M 50/184; H01M 50/186

(52) U.S. Cl. CPC H01M 50/105; H01M 10/0525; H01M 10/0587; H01M 50/119; H01M 50/121; H01M 50/129; H01M 50/136; H01M 50/178; H01M 50/184; H01M 50/186; B23K 26/206; B23K 2101/36; B29C 65/16; B29L 2031/3468

(57) ABSTRACT

A battery cell and methods for manufacturing battery cells are presented. The battery cell includes an electrode assembly with positive and negative tabs extending from opposite ends of the assembly. A casing of the battery cell fully encloses the electrode assembly, with the tabs extending through the casing. The casing includes a folded side sealed by folding, welded sides sealed by weld beads, and a bonded side sealed by a thermal bond. The combination of the fold, weld beads, and thermal bond provides a fully sealed enclosure for the battery cell.

### TECHNICAL FIELD

This disclosure relates to battery manufacturing.

### BACKGROUND

Pouch cell batteries are widely used for their flexibility, lightweight, and energy density.

### SUMMARY

A lithium-ion battery cell has an electrode assembly including positive and negative tabs extending from opposite ends thereof, and a casing enclosing the electrode assembly such that the positive and negative tabs extend there through, and defining a folded side via a fold, welded sides sealed via weld beads, and a bonded side sealed via a thermal bond such that the fold, the beads, and the bond combine to form a fully sealed enclosure. The casing may be a polymer sheet with an outer polymer layer, an aluminum layer, and an inner polymer layer. The casing may have an exposed aluminum layer that forms the beads. A sealant may be applied to the positive tab. The sealant may be tape. The electrode assembly may be in a jelly wound configuration.

A lithium-ion battery assembly includes a positive electrode with a positive tab stacked on a negative electrode with a negative tab, and a composite sheet folded over to enclose the positive electrode and the negative electrode with the positive tab protruding through a welded bead, the negative tab extending through a laminate formed by heat-sealing, and an adjacent section sealed by an additional welded bead, such that the composite sheet is fully sealed on all sides to form an enclosed pouch. The composite sheet may have an outer polymer layer, an aluminum layer, and an inner polymer layer. Welded beads may be formed by the aluminum layers. Insulating tape may be applied to cover exposed aluminum on the laser welded sides. The positive electrode and negative electrode may be wound into a jelly wound configuration.

A method of manufacturing a lithium-ion battery cell includes a casing folded over an electrode assembly with a positive tab extending through one side of the casing and a negative tab extending through an opposite side of the casing, the casing is laser welded along the positive tab and an adjacent side to seal the casing, the negative tab is heat sealed to fully enclose the casing and form a lithium-ion battery cell. The casing may be a multi-layer composite sheet including an outer polymer layer, a metal layer, and an inner polymer layer. The inner polymer layer may be removed from the first side and the adjacent side of the casing to expose the metal layer before laser welding. The laser weld may be performed using a continuous wave laser at a power level between 100 and 500 watts. A pressure clamp may be applied to maintain alignment of the casing during the laser welding process. The heat seal may be performed using temperatures between 150° C. and 250° C. and a pressure of between 0.1 MPa and 0.5 MPa. The method may include preheating the casing at the location of the heat seal. The laser weld may be performed at a speed between 10 mm/s and 50 mm/s. A voltage between the casing and the lithium-ion battery cell's electrodes may be measured.

### BRIEF DESCRIPTION OF THE DRAWINGS

FIG. 1 is a schematic diagram of a conventionally sealed lithium-ion battery cell;

FIG. 2 is a schematic diagram of a lithium-aluminum alloy in a conventionally sealed lithium-ion battery cell;

FIGS. 3-4 are schematic diagrams of hybrid sealed lithium-ion battery cells;

FIG. 5 is a schematic diagram of a welded edge of a lithium-ion battery cell; and

FIGS. 6A-6B are schematic diagrams of insulation on hybrid sealed lithium-ion battery cells.

### DETAILED DESCRIPTION

In accordance with this disclosure, embodiments of a lithium-ion battery cell and methods of manufacturing the cell are described in detail. The disclosed embodiments focus on a casing design, which includes a folded side sealed by folding, welded sides sealed via weld beads, and a bonded side sealed through thermal bonding. These features work together to create a fully sealed enclosure around the electrode assembly, ensuring durability and protection. The figures and descriptions provided illustrate key aspects of this sealing process but are not intended to represent every possible variation or configuration. Certain features may be emphasized or simplified to highlight the main sealing mechanisms. The structural and operational details described serve as a guide for those skilled in the art to implement various embodiments of the claimed invention without limiting its scope.

The disclosure relates to methods and components used in the manufacture of lithium-ion battery cells, including features related to the casing and sealing processes. While the general structure of the pouch-type lithium-ion battery remains consistent with conventional designs, specific modifications are introduced to increase sealing strength, durability, and efficiency in the manufacturing process.

Pouch film used in conventional lithium-ion batteries may be utilized, but certain modifications may be necessary for welding. Specifically, one side of the pouch should undergo laser welding. To ensure effective welding, an aluminum layer of the pouch film should be exposed without the polymer layer on both the inside and outside. There are not restrictions on the size or thickness of the pouch film, the material or thickness of the outer and inner polymer layers, or the material and thickness of the adhesive layer.

The electrode assembly may be either stacked or wound into a jelly wound, as is typical in conventional lithium-ion batteries. The current collectors for both the anode and cathode can also follow conventional designs. However, a sealant is required for the anode's current collector, specifically to increase adhesion between the negative terminal and the pouch film. This sealant is not necessary for the cathode positive terminal, setting it apart from traditional methods.

A variety of materials may be used depending on the desired battery performance. For the electrolyte, common options include lithium hexafluorophosphate in a mixture of organic solvents such as ethylene carbonate, diethyl carbonate, or dimethyl carbonate. The packaging pouch may consist of multi-layer composite materials, with common options including polyethylene terephthalate, polyamide, or polypropylene as the outer layer, with an aluminum foil barrier layer. The current collectors may be made from materials like copper for the anode and aluminum for the cathode, with optional coatings such as carbon or conductive polymers to increase adhesion and conductivity. These materials can be tailored based on specific battery requirements, offering flexibility in manufacturing.

In the manufacturing process, the electrode stack or jelly wound is placed into one of the two cup spaces formed by the pouch film, and the film is folded over to fully enclose the stack. The sealing process then involves laser welding and heat sealing to secure the pouch. The laser welding process starts with the side of the electrode stack or jelly wound that does not have terminals. The exposed area to the laser should be free of the polymer layer on both sides of the aluminum to ensure a strong weld. Three welding techniques may be employed: (1) welding the two layers of aluminum by applying the laser from the vertical direction of the upper pouch, (2) simultaneously welding the upper and lower pouches along their meeting line, or (3) welding at the end line where the upper and lower pouch layers meet after folding. For the positive terminal, only methods (1) and (3) may be used. The thickness of the positive terminal may require higher laser output or longer exposure times to maintain weld quality.

For the negative terminal side, the pouch is sealed using a high-temperature and pressure process. Heat is applied to the upper pouch, melting the polymer layer and causing it to adhere to the lower pouch, following the conventional method but adjusted for material thickness and properties. After laser welding, the exposed aluminum layer on the pouch is folded twice inward to conceal it, following standard pouch cell folding procedures. This prevents the aluminum from being exposed. Insulating tape, such as polyimide or polyethylene terephthalate, is then applied to secure the folded section, such that it remains covered and preventing electrical conduction.

After sealing, the pouch's exposed aluminum areas around the positive terminal are covered with polyimide or polyethylene terephthalate (PET) tape to prevent electrical conduction. The laser welding parameters, such as output, duration, pulse frequency, and spot size, are determined experimentally based on the thickness of the pouch material. Similarly, the temperature, pressure, and duration of the high-temperature and pressure sealing process are also determined experimentally, depending on the thickness of the polymer layers and the material properties.

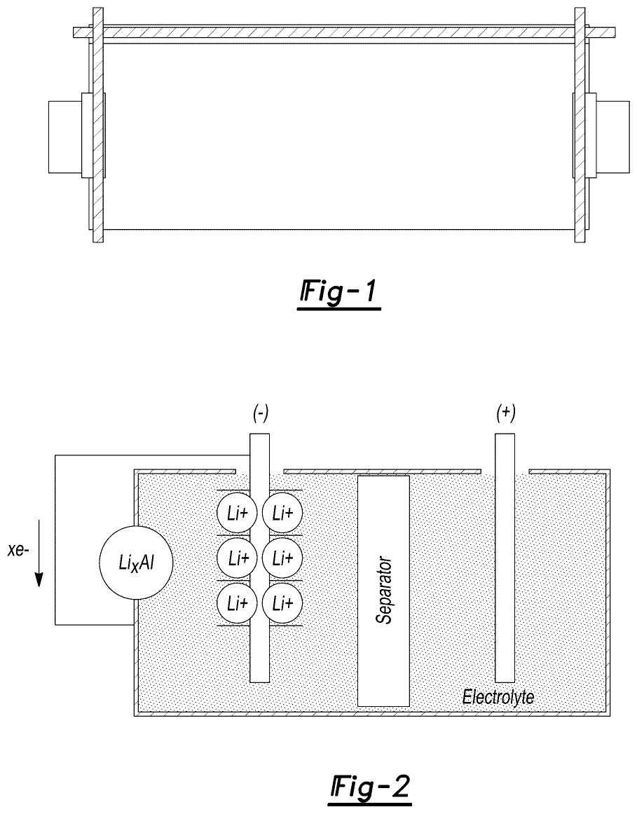

FIG. 1 is a conventional lithium-ion battery pouch cell. The cell has an electrode assembly enclosed within a flexible composite pouch, typically made from a multi-layer material consisting of an aluminum barrier sandwiched between polymer layers. The pouch is folded along one side, creating a complete enclosure for the electrode assembly, with the remaining three sides sealed using heat and pressure. Positive and negative terminals extend from opposite ends of the pouch, allowing connection to an external circuit.

One challenge with this conventional design is low sealing strength. The scaling process relies on the adhesive force of the polymer layers at high temperatures. When the battery operates at temperatures approaching the polymer's melting point, the seal may weaken, reducing its ability to endure internal gas pressures, particularly those exceeding 4 bar. In the event of significant gas generation inside the battery, the pouch film may need to open to release the pressure. However, the uniform adhesion of the polymer on three sides makes it difficult to predict where the pouch will rupture under pressure. This unpredictability complicates the design of effective venting mechanisms, as the location of gas release cannot be easily controlled.

The pouch film in FIG. 1 is also completely electrically neutral, meaning that it does not have any inherent polarity. As a result, a separate insulation test is required to verify that the film properly isolates the internal electrodes from the outside environment. Even after passing this test, there is no way to detect insulation lapses caused by thermal or mechanical shocks that occur during the battery's operation. Battery abnormalities or lapses due to such insulation breakdowns may go undetected for an extended period.

For the sealing process, each side of the pouch (other than the folded side) should be sealed in a high-temperature, high-pressure environment for 3-10 seconds. This leads to long process times and several drawbacks. Maintaining a consistent temperature across the pouch may be difficult, which results in variations in the quality of the seals. Prolonged exposure to high temperatures can also cause peripheral degradation to the pouch material or contamination. Additionally, to prevent premature venting due to low internal gas pressure, the width of the seals should be increased, which may result in greater material usage and additional complexity in the manufacturing process.

FIG. 2 is a schematic diagram of a process in conventional lithium-ion battery pouch cells involving the formation of a lithium-aluminum (Li—Al) alloy, a phenomenon that can occur when water infiltrates the cell. This process may lead to degradation of the cell. In lithium-ion cells, the presence of water is unwanted. Water ingress may occur due to poor sealing, causing degradation, or even during the manufacturing process. Once inside the battery, water reacts with the lithium in the electrolyte or electrode materials through a hydrolysis reaction. This reaction produces lithium hydroxide (LiOH) and hydrogen gas (H₂), as shown by the following reaction:

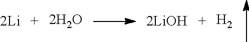

This reaction is exothermic, meaning it releases heat and raises the internal temperature of the cell. Elevated temperatures within the battery may quicken other unwanted reactions, including those involving aluminum. The LiOH produced during hydrolysis may react with the Al to form lithium aluminate (LiAlO₂). This process consumes aluminum from the current collector, which results in loss of electrical contact and possible degradation of battery performance:

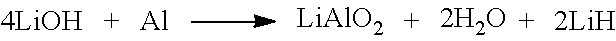

Furthermore, Li—Al alloy formation may occur directly when Li comes into contact with Al under certain conditions, particularly elevated temperatures caused by exothermic reactions. This alloy formation, as shown in FIG. 2, consumes lithium that would otherwise be available for the charge-discharge cycles, diminishing the cell's capacity. The reaction also weakens the Al structure by forming a brittle Li—Al alloy:

### Al Cathode:

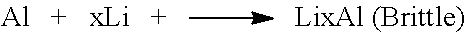

### Graphite Anode:

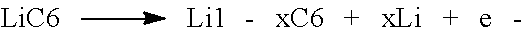

As shown in FIG. 2, this process may lead to the dissolution of the aluminum pouch layer and depletes the Li. Over time, these reactions cause the formation of non-conductive compounds on the aluminum current collector, increasing the cell's internal resistance.

FIG. 2 also shows the effect of voltage instability. When the aluminum pouch and negative terminal are electrically connected, the formation of the Li—Al alloy may cause the voltage to drop outside the expected operating range or become unstable. Therefore, measuring the voltage between the anode and cathode terminals may be an effective way to detect pouch film sealing issues. Voltage irregularities are an indicator of unwanted reactions between lithium and aluminum inside the battery.

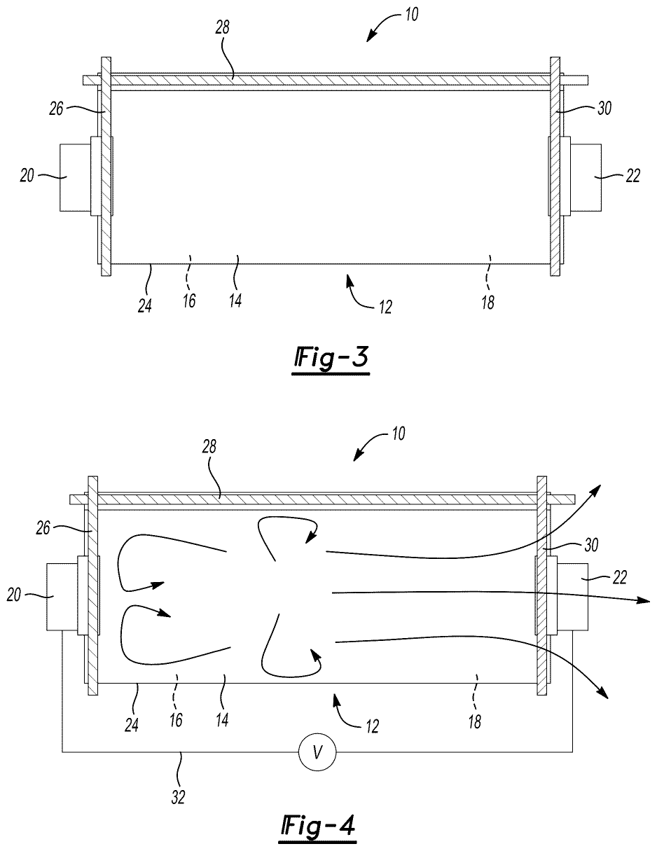

FIGS. 3-4 are schematic diagrams of a hybrid sealed battery pouch cell 10, which employs a combination of sealing techniques. The battery cell 10 includes a casing 12 that encloses an electrode stack or jelly wound 14. The electrode stack 14 includes a positive electrode 16 and a negative electrode 18, both of which are connected to external terminals. A positive terminal 20 is electrically connected to the positive electrode 16 and extends through the casing 12 on one side of the pouch. Similarly, a negative terminal 22 is connected to the negative electrode 18 and also extends through the opposite side of the casing 12, enabling electrical connection to an external circuit. These terminals allow the battery pouch cell 10 to interface with external devices.

The casing 12 is sealed using a combination of folding, laser welding, and heat sealing to maintain the integrity of the enclosure and to protect the internal components from external contaminants or environmental exposure. A folded side 24 is created by folding the casing 12 over the electrode stack 14. This fold 24 provides a natural seal along one side of the battery pouch cell 10.

The laser welded beads 26 and 28 are located along the sides of the casing 12 adjacent to the positive terminal 20 and negative terminal 22. Beads 26 and 28 are formed by applying a laser to exposed aluminum layers of the casing 12, welding the layers together. This provides a strong, precise seal that is capable of withstanding high pressures and temperatures, thus preventing leakage of the electrolyte or the ingress of water or oxygen. The laser welds ensure that the positive terminal 20 and negative terminal 22 are securely sealed in place, while also maintaining the electrical insulation between the internal components of the battery pouch cell 10 and the external environment.

The heat-sealed side 30 is formed by applying heat and pressure to the polymer layers of the casing 12 to melt and bond the layers together. Together, the folded side 24, laser-welded beads 26 and 28, and heat-sealed side 30 work in tandem to form the fully sealed battery pouch cell 10.

FIG. 4 shows battery pouch cell 10 with directional venting and a voltage detection system 32 for identifying packaging lapses. In this configuration, the positive terminal laser-welded bead 26 is not further sealed with a sealant, allowing controlled venting of gas through the designated areas of the pouch. The arrows in the figure indicate the flow of gas escaping from the positive terminal 20 due to internal pressure build-up.

The venting is strategically directed, ensuring that gases generated during overpressure events exit through specific channels without affecting the internal structure of the battery pouch cell 10. The laser-welded beads 26 and 28 and the heat-sealed side 30 maintain the overall integrity of the enclosure while allowing this directed venting.

Additionally, the battery pouch cell 10 includes a method for detecting packaging lapses by using a positive polarity voltage check. A voltage detection system 32, is used to monitor the voltage between the pouch's casing, which is electrically neutral, and the electrodes inside. Any variations in voltage may indicate a breach or lapse in the packaging or pouch seal, particularly around the positive terminal area where no sealant is applied. This early detection method allows for identifying issues in the packaging that may otherwise go unnoticed until the cell performance is degraded.

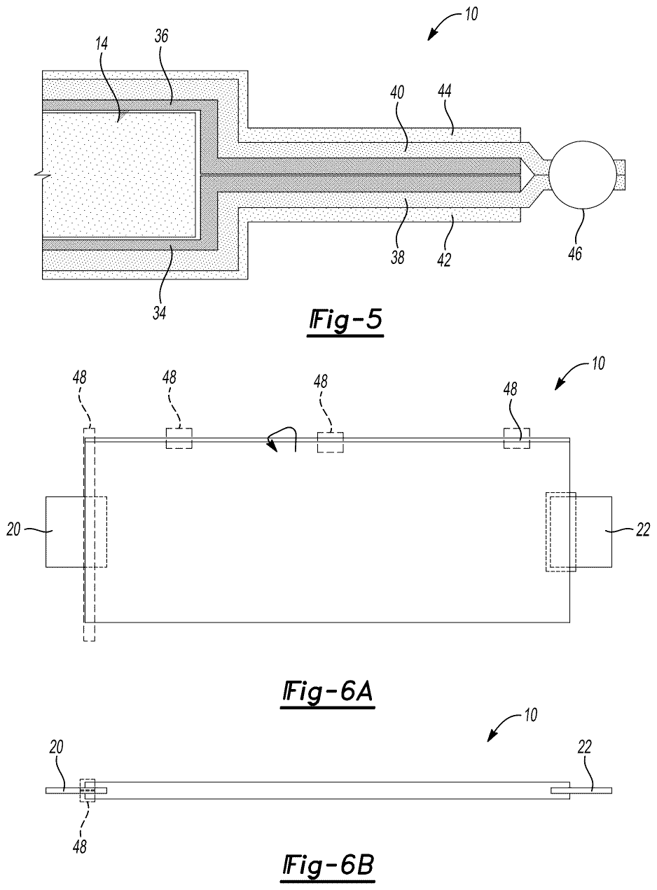

FIG. 5 is a schematic diagram of the structure of the casing 12 for the battery pouch cell 10, enclosing the electrode stack or jelly wound 14. The casing 12 includes multiple layers of materials for durability and sealing. A first polymer sheet 34 and second polymer sheet 36 act as outer protective layers. These may be made from materials such as PET, polyamide, or polypropylene, which offer mechanical strength and chemical resistance.

Between the polymer sheets are a first aluminum sheet 38 and second aluminum sheet 40, forming a barrier to prevent moisture and oxygen ingress. These aluminum layers may be 0.040 mm thick and provide the necessary protection to the internal components of the battery pouch cell 10 from environmental exposure.

Covering the aluminum layers 38 and 40 are additional polymer sheets, 42 and 44, which help to further secure the aluminum layers 38 and 40 and protect them from external environmental effects. These polymer layers 42 and 44 may also include cast polypropylene, which provides sealing properties during the heat-sealing process. The aluminum sheets, 38 and 40, are welded together at bead 46. Bead 46 represents a laser-welded joint that securely bonds the aluminum layers 38 and 40, providing a tight seal that prevents electrolyte leakage or external contaminants from entering the battery pouch cell 10.

FIGS. 6A and 6B show a lithium-ion battery pouch cell 10 that utilizes insulating tape 48 to secure sections of the casing 12 and increase the overall structural integrity of the pouch. In FIG. 6A, the tape 48 is applied at multiple locations along the folded and sealed sides of the casing 12 to secure areas that could be vulnerable to loosening. This includes the side near the positive terminal 20 and along the folded sections of the casing.

FIG. 6B shows a cross-sectional view of the battery pouch cell 10. The insulating tape 48 is applied around the positive terminal 20 and along the folded side, so that no part of the casing 12 becomes exposed. The tape 48 helps prevent electrical conduction and offers additional mechanical stability.

Although specific embodiments of a lithium-ion battery cell casing and methods for sealing the casing have been described in detail, these embodiments do not encompass every possible configuration. The language used in this specification is intended for illustrative purposes only and should not be construed as limiting the scope of the invention. Variations and modifications may be made without departing from the core principles of the invention. Furthermore, the features and elements of the disclosed embodiments, such as the folded side, welded sides, and bonded side, may be combined or altered in various ways to create additional embodiments that fall within the scope of the claimed invention, even if such combinations are not explicitly described in this specification.

What is claimed is:

1. A lithium-ion battery cell comprising:
an electrode assembly including positive and negative tabs extending from opposite ends thereof; and
a casing enclosing the electrode assembly such that the positive and negative tabs extend there through, and defining a folded side via a fold, welded sides sealed via weld beads, and a bonded side sealed via a thermal bond such that the fold, the beads, and the bond combine to form a fully sealed enclosure.

2. The lithium-ion battery cell of claim 1 wherein the casing is a polymer sheet with an outer polymer layer, an aluminum layer, and an inner polymer layer.

3. The lithium-ion battery cell of claim 1 wherein the casing has an exposed aluminum layer that forms the beads.

4. The lithium-ion battery cell of claim 1, further comprising a sealant applied to the positive tab.

5. The lithium-ion battery cell of claim 4 wherein the sealant is tape.

6. The lithium-ion battery cell of claim 1 wherein the electrode assembly is in a jelly wound configuration.

7. A lithium-ion battery assembly comprising:
a positive electrode including a positive tab stacked on a negative electrode with a negative tab; and
a composite sheet folded over to enclose the positive electrode and the negative electrode with the positive tab protruding through a welded bead, the negative tab extending through a laminate formed by heat-sealing, and an adjacent section sealed by an additional welded bead, such that the composite sheet is fully sealed on all sides to form an enclosed pouch.

8. The lithium-ion battery assembly of claim 7 wherein the composite sheet has an outer polymer layer, an aluminum layer, and an inner polymer layer.

9. The lithium-ion battery assembly of claim 8 wherein the welded beads are formed by the aluminum layers.

10. The lithium-ion battery assembly of claim 8, further comprising insulating tape applied to cover exposed aluminum on the welded beads.

11. The lithium-ion battery assembly of claim 7 wherein the positive electrode and negative electrode are wound into a jelly wound configuration.

12. A method of manufacturing a lithium-ion battery cell comprising:
folding a casing over an electrode assembly with a positive tab extending through one side of the casing and a negative tab extending through an opposite side of the casing;
laser welding the casing along the positive tab and an adjacent side to seal the casing; and
heat sealing along the negative tab to fully enclose the casing and form a lithium-ion battery cell.

13. The method of claim 12, wherein the casing is a multi-layer composite sheet including an outer polymer layer, a metal layer, and an inner polymer layer.

14. The method of claim 13, further comprising removing the outer and the inner polymer layer from the casing to expose the metal layer before laser welding.

15. The method of claim 12 wherein the laser welding is done using a continuous wave laser at a power level between 100 and 500 watts.

16. The method of claim 12, further comprising applying a pressure clamp to maintain alignment of the casing during laser welding.

17. The method of claim 12 wherein heat sealing is done using temperatures between 150° C. and 250° C. and a pressure of between 0.1 MPa and 0.5 MPa.

18. The method of claim 12, further comprising preheating the casing at a location of the heat seal.

19. The method of claim 12 wherein the laser welding is done at a speed between 10 mm/s and 50 mm/s.

20. The method of claim 12, further comprising measuring a voltage between the casing and electrodes of the lithium-ion battery cell.
